(19) United States
(12) Patent Application Publication
(10) Pub. No.: US 2013/0126424 A1
(43) Pub. Date: May 23, 2013

(54) ANAEROBIC PURIFICATION OF WASTE WATER IN AN UPFLOW REACTOR, AND METHOD OF IMPLEMENTING SAME

(71) Applicant: Stephan Bugay, Chateaurenard (FR)

(72) Inventor: Stephan Bugay, Chateaurenard (FR)

(73) Assignee: VALBIO, Portet Sur Garonne (FR)

(21) Appl. No.: 13/640,765

(22) PCT Filed: Apr. 19, 2011
(86) PCT No.: PCT/EP2011/056274

§ 371 Date: Feb. 5, 2013

(30) Foreign Application Priority Data
Apr. 20, 2010 (FR) 1052967

(51) Int. Cl. C02F 3/28

(52) U.S. Cl. CPC C02F 3/282
USPC 210/607; 210/150

(57) ABSTRACT

An anaerobic waste water purification upflow reactor, includes a vessel (1) containing biomass granules, elements for injecting influent into a lower part of the vessel, a three-phase separator (3) for separating gas, liquid and solid, which is located in an opposite upper part of the vessel, and elements for collecting effluent out of an upper part of the three-phase separator. The three-phase separator (3) includes two solid/liquid settlement zones (12, 13) positioned one above the other in the direction of the upflow (9), above a lower zone provided with gas separation element (10). The reactor includes effluent recirculation elements including element for extracting effluent from the vessel between the two settlement zones and element for re-injecting the extracted effluent into a lower part of the vessel (1).

This invention relates to a granular sludge and upflow type of anaerobic waste water purification reactor and a purification method implementing same.

Anaerobic purification upflow reactors, also known as methanation reactors or methanators, are routinely used to realize a natural biological purification of waste water using anaerobic bacteria that transform the pollutants, organic substances, into harmless components.

Such reactors conventionally comprise a vessel in which is placed a sludge bed, which consists of anaerobic bacteria growing in aggregates, forming what is commonly called a granular biomass, in expansion in water. The influent to be treated, generally waste water, is injected into the lower part of the vessel in a uniform distribution under the sludge bed. As it ascends towards the opposite upper part of the vessel it is treated by the bacteria, which transform the pollutants it contains into biogas, which consists mainly of methane and carbon dioxide. Driven by the gas bubbles, the biogas/sludge/water mixture thus formed rises towards the upper part of the vessel, in which a three-phase separator is positioned. This separator traditionally comprises gas deflector means placed under a solid/liquid settlement zone. It first of all carries out the degassing of the mixture, then the separation by settlement of the solid/liquid mixture thus freed of the gaseous portion. The decanted sludge particles sink to the bottom of the vessel. At the top of the reactor, on output from the three-phase separator, the biogas and an effluent, comprising the treated liquid and fine sludge particles that could not be separated from it by settlement, are collected. A portion of this effluent is re-circulated, i.e. re-injected into the lower part of the vessel, to take part in fluidizing the sludge bed contained in the vessel.

This invention aims to improve systems for treating waste water by anaerobic purification, by proposing an anaerobic purification upflow reactor that notably has a higher purification rate than existing reactors and provides a treated liquid effluent largely free of solid sludge particles.

To this end, according to the invention, an anaerobic waste water purification upflow reactor is proposed, which comprises a vessel containing biomass granules, more specifically in the form of a sludge bed in expansion, means of injecting influent into a lower part of this vessel so as to form in the latter a liquid upflow in the sludge bed, a three-phase separator for separating gas, liquid and solid, which is located in an opposite upper part of said vessel, and means of collecting effluent out of an upper part of the three-phase separator. This reactor is characterized in that the three-phase separator comprises two solid/liquid settlement zones positioned one above the other in the direction of the upflow, above a so-called lower zone provided with gas separation means, and in that it comprises effluent recirculation means that comprise means of extracting effluent from the vessel between the two settlement zones and means of re-injecting the effluent thus extracted into a lower part of the vessel.

Throughout this description, the terms upper and lower, above and below, top and bottom, etc. are defined relative to the upflow of liquid in the reactor; this flow being substantially vertical and going from the bottom towards the top.

The gas separation means of the three-phase separator according to the invention are standard in themselves. These are in particular deflectors, in the form of inclined annular plates, which separate the biogas, formed in the vessel by the action of the anaerobic bacteria on the influent, and the treated water/granular sludge mixture, by directing the gas away from the settlement zones positioned above the lower gas separation zone. These gas deflectors can have any shape; in particular they can have a circular or rectangular cross-section.

In the three-phase separator according to the invention, advantageously three successive solid/liquid settlement effects occur along the direction of the upflow.

First of all, an initial settlement effect occurs in the lower gas separation zone, in which the largest size of sludge particles present in the three-phase mixture settle down. After settling down, these heaviest particles naturally sink into the sludge blanket contained in the vessel, under the separator.

Above the deflectors, always in the upflow direction, two additional settlement effects occur in the three-phase separator; the first occurs in a settlement zone referred to as the intermediate zone, then the second occurs in a settlement zone referred to as the upper settlement zone.

According to the invention, a portion of the treated effluent reaching the three-phase separator is extracted from it between the two settlement zones, above the intermediate settlement zone. Advantageously this results in the effluent's flow rate in the upper settlement zone being slower compared to the flow rate in the intermediate settlement zone. As a consequence, there occurs in this upper settlement zone the settlement of finer sludge particles than in the intermediate settlement zone; such finer particles are not usually separated from the liquid phase by the three-phase separators of the prior art. This results in the treated effluent finally collected at the top of the separator having significantly improved cleanliness, clearness and quality compared to the reactors of the prior art.

In addition, the effluent collected between the intermediate and upper settlement zones is advantageously re-circulated in the vessel, so that it takes part in fluidizing the granular bed therein. The sludge granules, or particles, that it contains also contribute to maintaining the weight of sludge in the vessel at a substantially constant level over time. In addition these granules have a relatively small size, since the solid/liquid mixture reaching the top of the intermediate settlement zone has already advantageously been subjected to two successive settlement effects resulting in the heaviest granules having been eliminated. The improvement in the purification rate of the reactor according to the invention can be estimated to be 5 to 10% higher than that of reactors of the prior art.

The choice of re-circulating a portion of the treated effluent outside the vessel, in accordance with the invention, is also very advantageous, particularly as it allows the physico-chemical parameters of the re-circulated effluent parameters to be continually monitored outside the vessel, if necessary.

In the upper part of the separator the final treated effluent is recovered in a way that is standard in itself, by overflow or aspiration.

According to preferred embodiments, the invention also meets the following features, implemented separately or in each of their technically possible combinations.

In preferred embodiments of the invention, the reactor comprises means of stopping the effluent recirculation.

According to an advantageous feature of the invention the height of the intermediate settlement zone, measured in the direction of the liquid upflow, is less than or equal to the height of the upper settlement zone. Preferably, the respective heights of the two solid/liquid settlement zones are substantially equal.

In preferred embodiments of the invention, the means of extracting effluent between the two settlement zones comprise peripheral piping positioned in the separator between the two settlement zones, one wall of which is perforated, and which is connected to effluent aspiration means.

Similarly, the means of collecting effluent out of an upper part of the three-phase separator, above the upper settlement zone, preferably comprise peripheral piping positioned in the separator above the upper settlement zone, one wall of which is perforated, and which is connected to effluent aspiration means.

According to advantageous features of the invention, for any of the two settlement zones this peripheral piping can be associated with or replaced by a central pipe formed in a similar way.

In preferred embodiments of the invention, the intermediate and upper settlement zones are respectively delimited by peripheral walls that can have substantially the same shape or different shapes. These peripheral walls can have a shape that is cylindrical or conical, or a cross-section that is substantially rectangular, square, etc.

According to an advantageous feature of the invention, inclined strips are positioned in at least one settlement zone, preferably in both settlement zones. The effect of such strips, conventional in themselves, is to increase the settlement surface inside each settlement zone and, as a result, improve the quality of the final treated effluent.

In preferred embodiments of the invention, the influent injection means comprise a pipe extending into a lower part of the vessel and mounting elements for the pipe resting on a lower wall of the vessel.

Preferably the pipe has a continuous peripheral wall, i.e. it is not pierced by perforations. The mounting elements for the pipe are hollow tubes in hydraulic communication with the pipe; each comprises an opening oriented towards the lower wall of the vessel, preferably at an extremity opposite the pipe. Thus these elements advantageously provide both the mounting for the pipe inside the vessel and the injection of influent into it, directly into the bottom of the vessel, such that the treatment of the influent advantageously makes use of the granular sludge present under the main pipe. This sludge is not exploited in the reactors proposed by the prior art.

The invention also relates to a method of anaerobic waste water purification, by means of a reactor according to the invention, according to which the waste water is injected into a lower part of the vessel, a first volume of effluent is re-circulated, through extraction from the vessel between the two settlement zones and re-injection into a lower part of the vessel, and a second volume of effluent is collected from an upper part of the three-phase separator, above the upper settlement zone.

In preferred modes of implementation of the invention there are realized sequential stops in the recirculation; this advantageously makes it possible to ensure that the sludge particles that may have accumulated in the separator's lower gas separation zone sink in the vessel.

Lastly, the invention relates to a three-phase separator for an anaerobic waste water purification reactor having the above features.

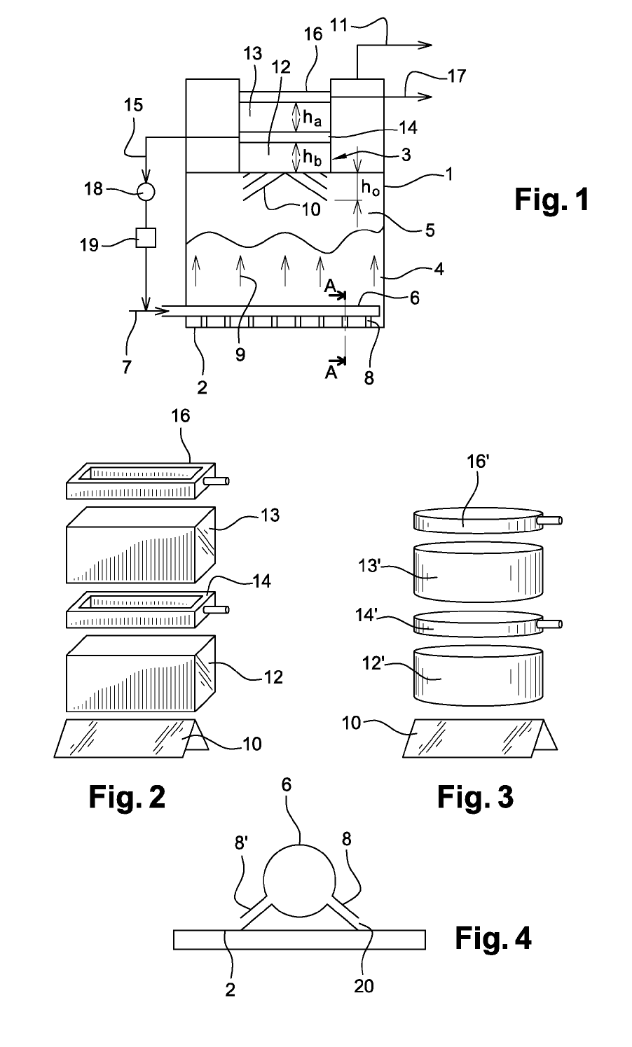

The invention will now be described more precisely in the context of preferred embodiments, that are in no way limiting, shown in FIGS. 1 to 4 in which:

FIG. 1 schematically represents an anaerobic waste water purification reactor according to the invention;

FIG. 2 shows, in an exploded view, an embodiment of a three-phase separator according to the invention;

FIG. 3 illustrates, in an exploded view, another variant of a three-phase separator according to the invention;

and FIG. 4 represents the lower part of the reactor in FIG. 1, in cross-section in plane A-A.

An anaerobic waste water purification reactor according to the invention is represented in FIG. 1.

This reactor comprises a vessel 1, delimited at the bottom by a lower wall 2, also called “floor”. A three-phase separator 3, designed to allow the separation of gas, liquid and solid, is positioned in its opposite upper part.

A bed of granular sludge 4, formed of aggregates of anaerobic bacteria mixed in water, is positioned inside the vessel 1, in its lower part. A sludge blanket 5 forms naturally above this sludge bed as a result of the formation of biogas in the vessel; this biogas creates a more turbulent sector above the sludge bed.

The reactor comprises means of injecting and distributing liquid influent to be treated, generally waste water, in a lower part of the vessel 1, under the sludge bed 4. These means mainly comprise a pipe 6, which extends inside the vessel 1, preferably substantially parallel to the bottom wall 2, and which is delimited by a peripheral wall, preferably continuous. This pipe 6 is connected to an injection pump, which supplies it with influent in the direction indicated by 7 in the figure.

The pipe 6 is supported inside the vessel by mounting elements 8, which rest on the bottom wall 2 of the vessel and are distributed at regular intervals, preferably over the entire length of the pipe. Preferably these mounting elements 8 are in hydraulic communication with the pipe 6 and pierced by at least one opening for introducing into the vessel 1 liquid brought by the pipe 6. They will be described in greater detail later in this description.

When, in accordance with a method of implementing the reactor according to the invention, the influent is injected into the bottom of the vessel 1, it is driven through the sludge bed 4 in an upflow, going from the bottom of the vessel towards its opposite upper part, in the direction 9 indicated in the figure, substantially vertically. There, the polluting substances it contains are converted by the anaerobic bacteria into a methane-rich gas, commonly known as biogas. The biogas/treated liquid/sludge particles mixture thus formed continues to rise towards the opposite top of the vessel 1, driven in particular by the gas, which creates turbulence above the sludge bed 4, forming the sludge blanket 5.

In the upper part of the vessel, the three-phase mixture reaches the three-phase separator 3.

This three-phase separator 3 comprises a lower part, known as the deflector zone, which is provided with means of separating the gas and the liquid/solid mixture. Preferably, these separation means are in the form of inclined annular plates, or deflectors 10. The gas deflectors 10 are standard in themselves and can take any form known to the person skilled in the art. In particular, any number and any arrangement of deflectors fall within the framework of the invention, insofar as this number and this arrangement allow an efficient separation of the biogas and liquid/solid mixture. In the preferred example of realization that is the subject of FIG. 1, three deflectors 10, arranged parallel to each other, are represented as an example.

The biogas thus separated continues its movement upward to the top of the vessel 1, where means for collecting it are positioned, in the direction 11 indicated in the figure. These collection means are standard in themselves.

In the lower deflector zone, at the deflector plates 10, a first solid/liquid settlement effect also occurs; this allows the largest size of sludge particles to be removed from the solid/liquid mixture. These particles sink naturally in the vessel. Above the deflectors 10, the upflow speed of the liquid/solid mixture, from which the gaseous portion has been removed, decreases.

Above the deflectors 10, in the direction of the upflow 9, the three-phase separator 3 according to the invention comprises two distinct settlement zones positioned one above the other, consisting of a settlement zone referred to as the intermediate zone 12 and a settlement zone referred to as the upper settlement zone 13. In each of these settlement zones, separation of the treated liquid and sludge particles by settlement occurs.

In preferred embodiments of the invention the respective heights, referred to as hₐ and h_{b}, of the intermediate settlement zone 12 and upper settlement zone 13 are substantially identical. Although particularly advantageous, such a relative sizing is nevertheless not restrictive of the invention. The height of the intermediate settlement zone 12 is preferably greater than or equal to 50 cm.

In the intermediate settlement zone 12, as there is less turbulence than in the lower part of the vessel 1 because of the absence of gas in the liquid/solid mixture, the heaviest sludge particles begin to settle. They sink into the lower deflector zone, where they accumulate. The liquid continues to rise towards the top of the separator. The biggest sludge particles have been separated from it by settlement.

The reactor comprises means of extracting treated effluent between the two settlement zones 12 and 13. Preferably these means consist of peripheral piping 14, positioned in the separator 3 between the intermediate settlement zone 12 and the upper settlement zone 13. The peripheral wall of this piping is pierced by holes. This piping 14 is associated with aspiration means, e.g. a recirculation pump 18 associated with a flowmeter 19, which are standard in themselves, and are configured to cause the effluent to be aspirated through the holes in the piping, out of the three-phase separator.

The effluent thus extracted, consisting of liquid and fine sludge particles, is directed, via a recirculation circuit of the reactor outside the vessel, towards re-injection means in the lower part of the vessel 1, in the direction indicated by 15 in the figure. Preferably, the re-injection is carried out by means of the injection pipe 6 and mounting elements 8 at the same time as the influent to be treated. Where necessary, the recirculation circuit can be associated to a system for regulating the re-circulated effluent's physico-chemical parameters, in particular the temperature and pH, before it is re-introduced into the vessel 1.

The re-circulated effluent flow rate is determined by calculations that fall within the competence of the person skilled in the art, according to the particular features of the vessel, granular sludge, influent, as well as the required quality of the final treated effluent.

In a particularly advantageous way, thanks to the presence in the vessel according to the invention of two separate settlement stages through which the effluent/sludge particles mixture passes before reaching the top of the intermediate settlement zone 12, the sludge particles contained in the re-circulated effluent are small in size, so that they undergo no or very little mechanical shearing in the aspiration pump 18, and the risk of these particles disintegrating is limited. These particles are re-injected into the vessel 1, where they are again able to participate effectively in treating the influent.

The effluent flow rate is lower in the upper settlement zone 13 than in the intermediate settlement zone 12. This results in a greater trapping of solid granules therein. There, finer sludge particles are separated from the treated liquid by settlement.

In the upper part of the separator 3, above the upper settlement zone 13, the reactor is provided with means of collecting effluent. For example, as shown in FIG. 1, these collection means consist of peripheral piping 16, a peripheral wall of which is pierced by holes for the aspiration of effluent. The piping 16 is associated to means, standard in themselves, of aspirating the final treated effluent out of the reactor, in the direction 17 indicated in the figure.

The final treated effluent can also be retrieved by overflow or, in variants of the invention, by one or more collection tubes positioned in a central part of the separator.

The sludge particles, even the fine particles, have been largely removed from the treated effluent thus collected. It therefore contains only a very few particles, and consequently it has a high level of cleanliness and clearness. The reactor according to the invention thus presents an enhanced purification action, improved in comparison to the reactors of the prior art.

In order to allow the sludge particles that accumulate in the lower deflector zone to sink into the sludge blanket located in the vessel, under the three-phase separator, a method of implementing the reactor according to the invention advantageously provides for the recirculation of effluent to be periodically interrupted, in particular by stopping the pump 18. During these sequential recirculation stoppage phases, as the effluent flow rate in the deflector zone is lower, the particles that were blocked in this zone sink back into the sludge blanket. In preferred modes of implementation of the invention, the proportion of time during which recirculation is stopped is between 5 and 50%, preferably between 20 and 40%. Such a choice of the value range for this time proportion advantageously ensures that all sludge particles that may stagnate in the lower deflector zone are eliminated and returned to the sludge blanket 5.

Two realization variants of the three-phase separator according to the invention are shown in FIGS. 2 and 3 respectively.

In general, each settlement zone 12, 13 is delimited by a peripheral wall that can be of any shape.

In the example of realization illustrated in FIG. 2, each settlement zone 12, 13 has a substantially rectangular cross-section. Each associated piping 14, 16 has an external contour with a shape substantially similar to that of the settlement zone over which it extends.

In the example of realization shown in FIG. 3, each settlement zone 12′, 13′ has a substantially circular cross-section.

The invention does not, however, exclude any other configuration of the settlement zones, and in particular configurations in which the intermediate settlement zone 12 and the upper settlement zone 13 are delimited by peripheral walls with different shapes.

A particularly preferred example of realization of the means of injecting influent into the vessel in the context of the invention is shown in greater detail in FIG. 4.

In this preferred embodiment of the invention, the mounting elements 8 for the pipe 6 are hollow tubes in hydraulic communication with the pipe 6 through one extremity and resting by their opposite extremity on the bottom wall 2 of the vessel. Preferably at this extremity resting on the bottom wall of the vessel, these tubes 8 have an opening 20 directed towards the bottom wall 2, so that they inject influent into the vessel 1 in the direction of this bottom wall. Each opening 20 is preferably in a plane substantially perpendicular to the bottom wall 2 of the vessel, so that the injection is performed at an angle relative to this bottom wall and as close as possible to it.

Preferably, tubes 8, 8′ are positioned on either side of a longitudinal axis of the pipe 6, and extend from it at an angle of approximately 45 degrees from this longitudinal axis so as to form a stable support on the bottom wall 2 of the vessel, as shown in FIG. 4. In the embodiment shown in this figure, the tubes 8, 8′ are associated in pairs, each positioned in the same plane transverse to the pipe 6; however, such an embodiment is in no way restrictive of the invention.

The characteristic parameters of the reactor according to the invention are generally defined according to calculations that fall within the competence of the person skilled in the art. In particular, the throughput is determined as a function of the surface area of the vessel and the mass loading applied to the bacteria. The effluent recirculation flow rate is determined such that the throughput, which is equal to the sum of the influent supply flow rate and the recirculation flow rate, remains constant over time (apart from the phases when the recirculation is stopped).

During the implementation of the purification method according to the invention, three successive levels of settlement occur in the three-phase separator 3.

A first portion of the sludge particles contained in the mixture reaching the three-phase separator 3, with a diameter greater than a value referred to as DPₒ, is separated in the lower deflector zone. These particles sink in the vessel, into the sludge blanket 5.

The particles with a diameter less than DPₒ reach the intermediate settlement zone 12. In this zone the particles with a diameter greater than a value referred to as DPₐ settle. These particles sink into the lower deflector zone, where they accumulate until the next time recirculation is stopped. During such a stoppage they then sink into the sludge blanket 5.

One portion of the particles with a diameter less than DPₐ is extracted from the separator with the re-circulated effluent, and the other portion reaches the upper settlement zone 13. Once again, in this zone the largest particles, with a diameter greater than a value referred to as DP_{b}, settle.

The particles with a diameter less than DP_{b} are collected with the final treated effluent.

In general, according to Stokes law, which is known to the person skilled in the art, the values DPₒ, DPₐ, DP_{b} are related to the different parameters of the reactor, the method for implementing it, the sludge granules and the effluent.

Two examples of configurations of the reactor according to the invention and the method for implementing same are given below solely for illustration purposes.

The values of the various parameters of the reactor and the method for implementing same, for each of these Examples 1 and 2, are indicated in table 1 below.

TABLE 1
Parameters of the reactor and the method for implementing same

| Parameter | Example 1 | Example 2 |
|---|---|---|
| Perimeter of the deflector zone (m) | 15 | 15 |
| Height hₒ of the deflector zone (m) | 1 | 0.7 |
| Number of deflector plates 10 | 3 | 6 |
| Settlement surface area of the intermediate zone | 75 | 75 |
| 12 (m²) | | |
| Height hₐ of the intermediate settlement zone | 0.7 | 0.7 |
| 12 (m) | | |
| Settlement surface area of the upper zone 13 (m²) | 12 | 12 |
| Height h_{b} of the upper settlement zone 13 (m) | 0.7 | 0.7 |
| Difference in density between the sludge particles | 10 | 10 |
| and the effluent (kg/m³) | | |
| Viscosity of the effluent (Pa · s) | 0.001 | 0.001 |
| Throughput (m³/h) | 75 | 75 |
| Supply flow rate (m³/h) | 5 | 40 |
| Recirculation flow rate (m³/h) | 70 | 35 |
| Proportion of time during which recirculation | 37.5% | 32 |
| stopped | | |

For each of examples 1 and 2, the maximum diameter of the sludge particles, as obtained at the top of each of the three zones of the three-phase separator, is indicated in table 2 below.

TABLE 2
Maximum diameter of the particles at the top of each zone of the three-
phase separator according to the invention

| Maximum diameter of the particles | Example 1 | Example 2 |
|---|---|---|
| DPₒ (μm) | 291 | 246 |
| DPₐ (μm) | 225 | 225 |
| DP_{b} (μm) | 142 | 164 |

The results presented in table 2 above clearly show that the particles on output from the upper settlement zone 13, i.e. the particles that are evacuated in the final treated effluent, have an advantageously very small size. The final treated effluent thus has a high degree of cleanliness. The particles on output from the intermediate settlement zone 12, i.e. the particles likely to be evacuated in the re-circulated effluent, also have a small maximum size. The largest particles have settled down in the lower deflector zone of the separator.

It is also noted that, for both of these implementation examples, applying sequential recirculation stoppage steps allows any long-lasting accumulation of sludge particles in the lower deflector zone to be avoided effectively. The particles that settle down in the deflector zone and the intermediate settlement zone 12 sink completely in the vessel 1 where they participate, with the particles contained in the recirculated effluent, in maintaining a substantially constant weight of active sludge in the vessel over time. Only a small amount of sludge particles, the finest, end by being extracted from the reactor with the final treated effluent, which is collected in the upper part of the three-phase separator. This results in an improved purification rate for the reactor compared to the devices proposed by the prior art.

The above description clearly illustrates that, through its various features and their advantages, the present invention realizes the objectives it set itself. In particular, it provides an anaerobic waste water purification upflow reactor with granular sludge that comprises a three-phase separator for separating biogas/granular sludge/treated effluent via a triple-effect of settlement and a double backfeed of sludge granules in the vessel, firstly by the recirculated effluent, by a circuit outside the vessel, and secondly directly from the lower gas separation zone. This reactor and the method for implementing it make it possible to obtain a treated liquid effluent with a high degree of cleanliness, largely free of sludge particles, including fine-sized particles, and with a high purification rate. Indeed, they ensure in particular that the particles fed back into the vessel, either through recirculation or directly from the lower deflection zone, retain their integrity and effectiveness of purification action.

1-10. (canceled)

11. Anaerobic waste water purification upflow reactor, comprising a vessel (1) containing biomass granules, means of injecting influent into a lower part of said vessel, a three-phase separator (3) for separating gas, liquid and solid, which is located in an opposite upper part of said vessel, and means of collecting treated effluent out of an upper part of said three-phase separator, wherein the three-phase separator comprises two solid/liquid settlement zones (12, 13) positioned one above the other in the direction of the upflow (9), above a lower zone provided with gas separation means (10), and said reactor comprises effluent recirculation means that comprise means of extracting effluent from said vessel between said two settlement zones and means of re-injecting the extracted effluent into a lower part of the vessel (1).

12. Reactor according to claim 11, comprising means of stopping the effluent recirculation.

13. Reactor according to claim 11, wherein the respective heights of the two solid/liquid settlement zones (12, 13) are substantially equal.

14. Reactor according to claim 11, wherein the gas separation means comprise deflector plates (10).

15. Reactor according to claim 11, wherein the effluent extraction means between the two settlement zones (12, 13) comprise peripheral piping (14) positioned in the separator (3) between said two settlement zones, one wall of which is perforated, and which is connected to effluent aspiration means.

16. Reactor according to claim 11, wherein inclined strips are positioned in at least one settlement zone.

17. Reactor according to claim 11, wherein the influent injection means comprise a pipe (6) extending into a lower part of the vessel (1) and mounting elements (8) for said pipe resting on a lower wall (2) of the vessel (1).

18. Reactor according to claim 17, wherein the mounting elements (8) for the pipe (6) are hollow tubes in hydraulic communication with said pipe and comprising an opening (20) oriented towards the lower wall (2) of the vessel (1).

19. Method of anaerobic waste water purification, which comprises: providing a reactor according to claim 11; injecting the waste water into a lower part of the vessel (1); re-circulating a first volume of effluent, through extraction from said vessel between the two settlement zones (12, 13) and re-injection into a lower part of the vessel (1); and collecting a second volume of effluent from an upper part of the three-phase separator (3).

20. Method according to claim 19, whereby sequential stops are realized in the recirculation.

21. Reactor according to claim 16, wherein inclined strips are positioned in both settlement zones (12, 13).

22. Anaerobic waste water purification upflow reactor, comprising:
a vessel (1) containing biomass granules,
means of injecting influent into a lower part of said vessel,
a three-phase separator (3) for separating gas, liquid and solid, which is located in an opposite upper part of said vessel, and comprising two solid/liquid settlement zones (12, 13) of substantially equal respective heights positioned one above the other in the direction of the upflow (9), above a lower zone provided with gas separation means comprising deflector plates (10),
means of collecting treated effluent out of an upper part of said three-phase separator,
effluent recirculation means that comprise means of extracting effluent from said vessel between said two settlement zones and means of re-injecting the extracted effluent into a lower part of the vessel (1),
and means of stopping the effluent recirculation.

23. Reactor according to claim 22, wherein the influent injection means comprise a pipe (6) extending into a lower part of the vessel (1) and mounting elements (8) for said pipe resting on a lower wall (2) of the vessel (1), said mounting elements being hollow tubes in hydraulic communication with said pipe and comprising an opening (20) oriented towards the lower wall (2) of the vessel (1).
